(19) United States
(12) Patent Application Publication
(10) Pub. No.: US 2021/0016273 A1
(43) Pub. Date: Jan. 21, 2021

(54) RAPID SPERM SEPARATION BASED ON SPERM MORPHOLOGY AND MOTILITY

(71) Applicant: University of Utah Research Foundation, Salt Lake City, UT (US)

(72) Inventors: Bruce Gale, Salt Lake City, UT (US); Alex Jafek, Salt Lake City, UT (US); Haidong Feng, Salt Lake City, UT (US); Timothy Jenkins, Salt Lake City, UT (US); Kenneth Aston, Salt Lake City (US)

(21) Appl. No.: 16/933,253

(22) Filed: Jul. 20, 2020

Related U.S. Application Data
(60) Provisional application No. 62/876,434, filed on Jul. 19, 2019.

(51) Int. Cl. B01L 3/00; B01L 3/02

(52) U.S. Cl. CPC B01L 3/5027; B01L 2300/0681; B01L 3/0275

(57) ABSTRACT

A method of isolating sperm of a fluid sample comprises separating, in an initial separation operation, the fluid sample via a microfluidic separating system into a first debris fluid volume and a first sperm fluid volume, and then reflowing the first sperm fluid volume and a dilution fluid through the microfluidic separating system to recycle the first sperm fluid volume, and then separating, in a subsequent separation operation, the first sperm fluid volume into a second debris fluid volume and a second sperm fluid volume via the microfluidic separating system.

### RELATED APPLICATIONS

This application claims priority to U.S. provisional application No. 62/876,434 filed Jul. 19, 2019, which is incorporated herein by reference.

### GOVERNMENT INTEREST

This invention was made with government support under Grant Number HD095355 awarded by the National Institutes of Health. The government has certain rights in the invention.

### BACKGROUND

Intrauterine insemination (IUI) is a commonly utilized assisted reproductive technique. In IUI, sperm that have been selected from a semen sample are injected into the uterus to initiate pregnancy. The sperm selection has three purposes: (1) separate the sperm cells from contaminating debris, especially white blood cells, (2) remove the majority of the prostaglandin-containing seminal plasma, and (3) reduce the sample volume to less than 1 ml. While there are existing, accepted methods for performing this preparation, there are issues with cost effectiveness, timelines, and the amount of sperm recovered. Accordingly, research continues into more efficient methods of sperm recovery that improve on timeliness and the sperm recovery rate.

### SUMMARY

A method of isolating sperm in a fluid sample can include separating, in an initial separation operation, the fluid sample via a microfluidic separating system into a first debris fluid volume and a first sperm fluid volume. Following the separation, the method can include reflowing the first sperm fluid volume and a dilution fluid through the microfluidic separating system to recycle the first sperm fluid volume. In a subsequent separation operation, the first sperm fluid volume can be separated into a second debris fluid volume and a second sperm fluid volume via the microfluidic separating system.

There has thus been outlined, rather broadly, the more important features of the invention so that the detailed description thereof that follows may be better understood, and so that the present contributions to the art may be better appreciated. Other features of the present invention will become more clear from the following detailed description of the invention, taken with the accompanying drawings and claims, or may be learned by the practice of the invention.

### BRIEF DESCRIPTION OF THE DRAWINGS

FIG. 1 illustrates a basic flow diagram of a method for washing sperm of a fluid sample through successive or repetitive separation processes through a microfluidic spiral structure, in accordance with an example of the present disclosure.

FIG. 2 is a schematic illustration of a method for washing sperm of a fluid sample through successive or repetitive separation processes through a microfluidic spiral structure, in accordance with an example of the present disclosure.

FIG. 3 is a schematic illustration of a method for washing sperm of a fluid sample through successive or repetitive separation processes through a microfluidic spiral structure, in accordance with another example of the present disclosure.

FIG. 4 is a schematic illustration of a microfluidic spiral structure, in accordance with an example of the present disclosure.

FIG. 5 is a schematic illustration of how white blood cells and sperm focus in a channel based on Dean-coupled elasto-inertial focusing and inertial Dean focusing forces.

FIG. 6 is a schematic illustration of a separation system run in parallel, in accordance with one example of the present disclosure.

FIG. 7 is a schematic illustration of a separation system including a spiral microfluidic device which automatically repeats the reflowing operation, in accordance with still another example of the present disclosure.

FIG. 8 is a schematic illustration of a filtration device, in accordance with an example of the present disclosure.

FIG. 9 is a graph of results of basic and enhanced recovery protocols, in accordance with an example of the present disclosure.

FIG. 10 is a graph illustrating comparison between motility, viability and DNA damage results between DGC and microfluidic approach, in accordance with an example of the present disclosure.

FIG. 11 is a graph of percentage of white blood cells directed to the unselected portion as a function of cycles and a subset of the data is shown in a subsequent graph, in accordance with one example.

FIG. 12 is a graph of percentage of sperm lost to the unselected portion as a function of cycles, in accordance with another example of the present disclosure.

FIG. 13 is a graph showing recovery percentage of semen via four outlets of a microfluidic separation device, in accordance with another example of the present disclosure.

FIG. 14 is a graph showing average recovery as a function of collection flow rate in one example of the present disclosure.

FIG. 15 is a graph showing average recovery as a function of collection flow rate in one example of the present disclosure.

FIG. 16 is a graph showing average recovery as a function of collection flow rate in one example of the present disclosure.

FIG. 17A is a graph showing fluorescent intensity as a function of channel width for several different particle types, in one example of the present disclosure.

FIG. 17B is a graph showing fluorescent intensity as a function of channel width for several different particle types, in one example of the present disclosure.

These drawings are provided to illustrate various aspects of the invention and are not intended to be limiting of the scope in terms of dimensions, materials, configurations, arrangements, or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise. Thus, for example, reference to “a particle” includes reference to one or more of such materials and reference to “subjecting” refers to one or more such steps.

As used herein, the term “about” is used to provide flexibility and imprecision associated with a given term, metric, or value. The degree of flexibility for a particular variable can be readily determined by one skilled in the art. However, unless otherwise enunciated, the term “about” generally connotes flexibility of less than 1%, and most often less than 0.5%, and in some cases less than 0.01%.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, and combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Rapid Sperm Separation

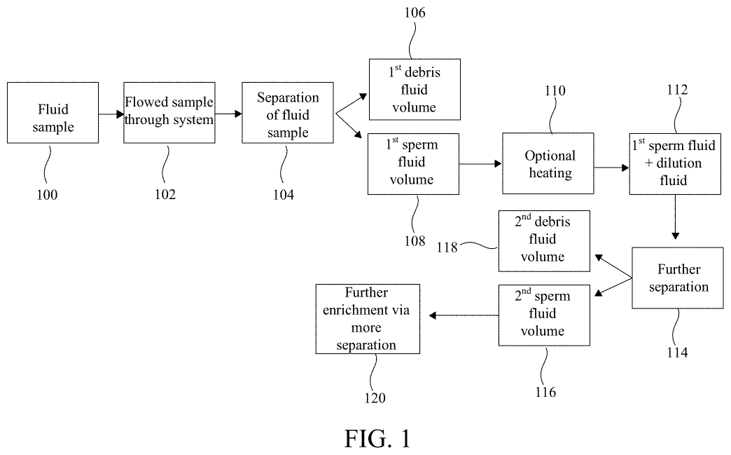

FIG. 1 illustrates a basic flow diagram for a method of isolating sperm, which includes obtaining a fluid sample 100. The fluid sample can be flowed through a microfluidic separating system 102 that separates, as indicated in 104, a first batch of sperm fluid volume 108 from a corresponding first batch of debris fluid volume 106. The first batch of sperm fluid volume 108 is taken and reflowed through the microfluidic separating system with a dilution fluid, as indicated in step 112. This subjects the first batch of sperm fluid volume 108 to additional separation forces. Prior to the 112 steps of reflowing, as indicated in 110, the sperm can optionally be maintained at target temperature until it is reflowed. The heating of the sperm is to ensure that it is maintained at a temperature of viability if it is not immediately reflowed through the separating system. If no heating occurs and sperm viability is maintained, then the process can proceed from 108 directly to 112. This can be followed by additional separation operations 114, where the first batch of sperm fluid volume separates into a second batch of sperm fluid volume 116 and second batch of debris fluid volume 118. Depending on the specific fluid, and channel dimensions, the number of reflow stages can range from one to fifteen, and most often five to twelve reflow stages. Additional separation operations act to further enrich the sperm fluid volume as indicated in 120.

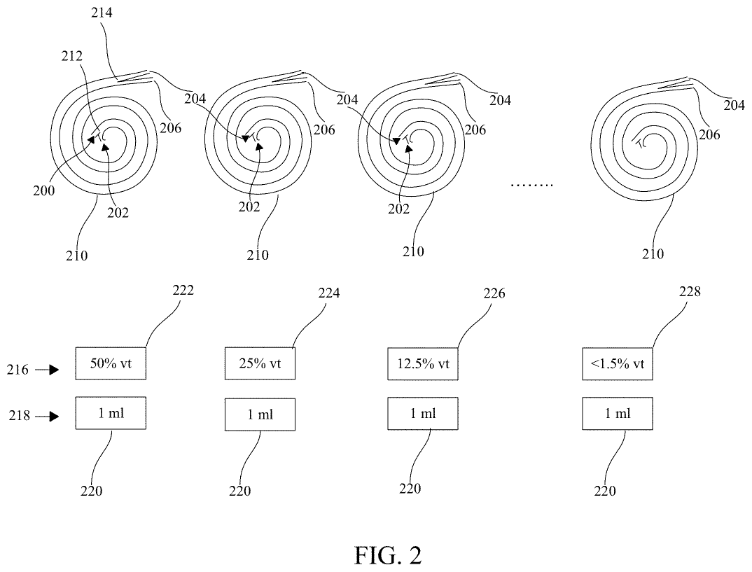

The mentioned method of repeating the reflowing operation is further explained with attention to the dilution fluid that is added on subsequent reflows. For instance, as indicated in FIG. 2, the inlet 212 of spiral microchannel structure 210 can include a sperm inlet 200 for receiving a fluid sample or a washed sperm fluid volume during a reflowing operation, and a dilution fluid inlet 202 that can receive a dilution fluid (e.g. from a syringe, pump or other source). As an example, for inlet 200, liquefied semen containing around 1 ml can be added. While inlet 202 which can receive the dilution fluid also is added in the volume of around 1 ml. Semen samples can be diluted with media such that there is not an excessive pressure created from the fluid viscosity of the semen sample. Besides this, the illustration in FIG. 2 does not require any pre-processing of the sample. In one alternative, the sample can be diluted during the initial cycle.

The spiral conformation of the microchannel is beneficial because it allows for tight control over the fluid and particles and enables unique microscale physics phenomena. Although illustrated as a planar spiral, other spiral configurations can be suitable such as, but not limited to, helical, coiled, or the like. For example, in some cases, a radius of curvature can progressively increase from an inlet to an outlet. However, in other cases, the radius of curvature can be maintained substantially constant.

The spiral microchannel in FIG. 2 does not depend on sperm motility but can separate based on shape. With each subsequent separation operation, sperm cells are further separated from debris in the fluid volume and the dilution fluid helps with the effectiveness of sperm separated from debris. Outlet 214 is where the sperm fluid and debris fluid come out separated from each other. This can happen because the outlet can contain a branched flow splitter where the enriched sperm flows through sperm outlet 204 and the debris flows through debris outlet 206. Outlet 204 typically contains sperm with some white blood cells (WBCs) because the sperm is typically not completely separated. Although sperm outlet 204 is illustrated as a single outlet, in some cases multiple sperm outlets can be included (i.e. at least one debris outlet 206 and more than one sperm outlets). Because there are still WBCs contaminants, reflow through the microfluidic separating system aids in further enriching the sperm sample. The sperm sample outputted from outlet 204 contains around 1 ml while the unselected portion outputted from outlet 206 also contains around 1 ml. The unselected debris that comes out of 206 (typically enriched WBC's) is discarded, while the sperm and other particles that have not been separated are rerun through the separating system to ensure further enrichment of the sperm sample. The output of the sperm sample from 204 is not reflowed alone but is accompanied by dilution fluid 202. This separation operation can be repeated multiple times until the final fluid sample is sperm rich, as indicated in FIG. 2. Unlike conventional methods, prior to entering the spiral microchannel illustrated in FIG. 2, the fluid volume does not require pre-processing or post-processing. However, in some aspects, fluid volume can be diluted with the dilution fluid as a pre-processing step.

The accompaniment of dilution fluid with the sperm sample from 204, was discovered to help with separation. The dilution fluid seems to be effective in sperm separation due to the physical properties of sperm. The conventional gold standard procedure for sperm separation and enrichment is a method known as density gradient centrifugation (DGC). Centrifugal washes are somewhat of a concern because it exposes sperm cells to centrifugal forces, introduces manual transfer steps or other steps, and increases the overall cost of the procedure. Thus, the present invention is important because it avoids the step of centrifugation completely.

As indicated in FIG. 2, the steps of filtering and mixing are essentially eliminated such that a robust and integrated microfluidic system that only uses dilution is provided. The sperm sample output 204 can be subjected to repeated passes of the spiral channel and two modes of operations can be used: reduction or dilution. The main difference between the two modes is the choice between adding and not adding media with each successive run. In the reduction mode, the repeated infusion of the selected portion causes the seminal plasma concentration volume to be reduced. In the dilution operating mode, media (i.e. dilution fluid) is added at a constant volume with each successive run which causes the seminal plasma to be diluted. Both methods can be performed without causing significant sperm loss. In FIG. 2, the operating mode shown is one of dilution where the seminal plasma volume is reduced due to adding a constant volume of media 202. See 220 where it indicates that the output sample volume stays the same while 222-228 indicates the seminal plasma dilution is reduced with each run.

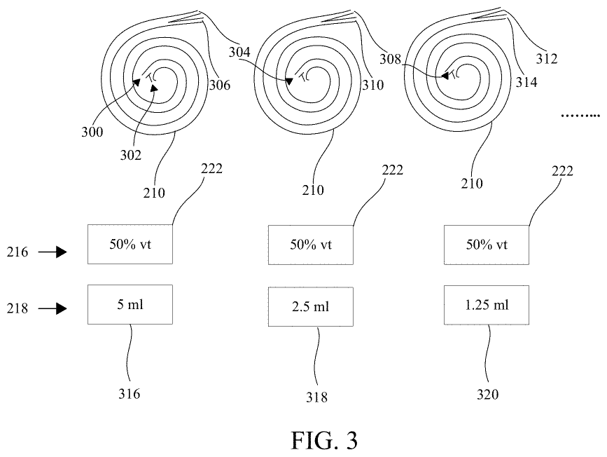

In contrast, FIG. 3 shows an operation mode of reduction as indicated by the output sample volume 218, where conditions 316-320 is shown to be reduced with each successive run. Seminal plasma dilution 216 is shown to stay consistent at 50% vt (indicated by 222) with each successive run. FIG. 3 shows a 5 ml liquefied semen 300 that is inputted into spiral microfluidic separating system 210. While 5 ml of media 302 is inputted with liquefied semen 300. Like FIG. 2, these samples are flowed through the spiral microfluidic separating system 210 and separate into an enriched sperm sample 304 (that likely still contains WBCs) and an unselected portion 306. Both the enriched sperm sample 304 and unselected portion 306 are 5 ml. The sperm sample 304 is rerun through the spiral microfluidic separating system and is further enriched as indicated by 308 but is now a 2.5 ml volume sample. Depending on specific conditions, the selected sperm volume represents about 50% to 70% of the channel width, and in some cases about 60%. The unselected portion 310 is also 2.5 ml. On the third run, sperm sample 308 is run through the spiral microchannel separating system again and the sperm output 312 is 1.25 ml while the unselected portion is also 1.25 ml. Thus, FIG. 3 shows the seminal plasma concentration volume being reduced in half with each run. This can be repeated until a desired sperm enrichment volume is reached. The flow of fluids in the spiral channel device can be controlled with two syringe pumps. One syringe pump infuses the sample and one withdraw the selected portion of the sample. A small tube extending from the unselected portion of the spiral channel imposes a significant back pressure such that fluid preferentially exits the selected portion according to the flow rate of the attached syringe pump. The ratio of the infusing to the withdrawing pump determines the selection percentage, which can be varied.

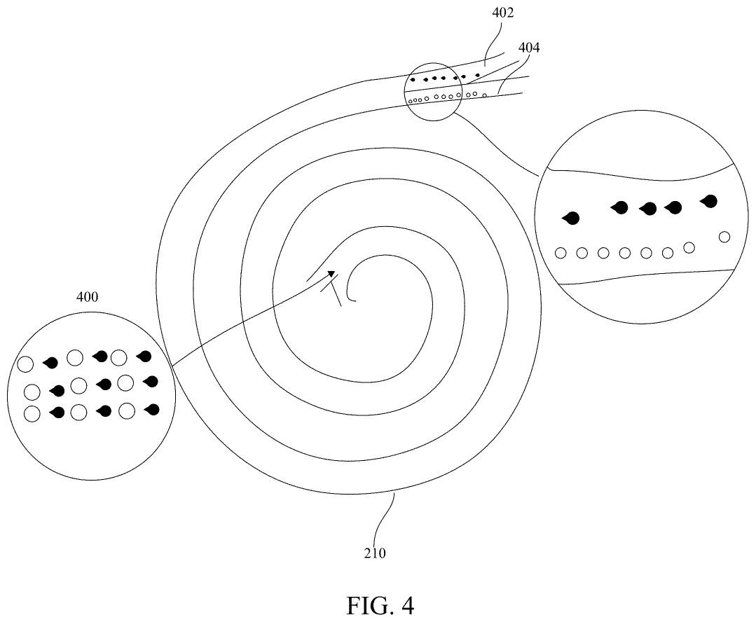

FIG. 4, schematically illustrates a mixture of WBCs and sperm 400 at the inlet of spiral microchannel separator 210. After the mixture of WBCs and sperm flow through the spiral channel the sperm and WBCs are separated into streams of enriched WBCs 404 and enriched sperm cells 402 at the branched splitter outlet. But the sperm does not always effectively separate from the WBCs.

To provide a system that reduces additional user interactions and effectively separates and enriches liquefied semen, the operation modes of dilution and reduction discussed above can be combined. Combining the two methods can allow for a much faster process time, automation of sperm preparation and better results than the typical DGC technique. This can be achieved by connecting the dilution and the reduction in series. This combination overcomes the problem of ineffective separation of sperm from WBCs and the problem of cells clogging in a tangential filter. The sperm and WBCs sometimes are directed to the same selected outlet due to the unique physical properties of seminal plasma. Dilution aids in separating WBCs from sperm by making the seminal plasma progressively more Newtonian. Non-limiting examples of suitable dilution fluids can include saline solution.

Although results can vary based on specific configurations, The final fluid sample can often comprise at least 65% of the sperm cells that were contained in the fluid sample prior to the initial separation operation. Thus, the initial fluid sample prior to the initial separation operation may be “debris rich” because there is more debris (e.g., WBCs) in the fluid sample than sperm cells. For instance, debris rich can mean that a majority (i.e., >50%) of the material in the initial fluid sample is something other than sperm cells, such as debris including WBCs and other matter or fluid. However, the final fluid sample can be sperm rich because there is more sperm cells in the final fluid sample than debris (e.g., 65% sperm cells or more of the original fluid sample, and 3% or less of the WBCs from the original fluid sample). Although results can vary based on specific configurations, The final fluid sample can often comprise at least 65% of the sperm cells that were contained in the fluid sample prior to the initial separation operation.

In one example, the syringe pumps that regulate infusing the sample and withdrawing the selected portion of the sample operates at a selection percentage of 60%. In one example, the seminal plasma dilution with minimal sperm loss is at 2%.

In another example, the combination of dilution and reduction steps in the spiral microfluidic separating system makes it possible to process a 3 mL sample in around 15 minutes.

In one example, the final fluid sample is produced in less than 20 minutes from the initial separation operation. For instance, in an automated sperm isolation process discussed above, a final fluid sample can be produced in 15 minutes or less.

In one example, the final fluid sample is 2.5 mL or less, which can be provided in a removable syringe of the microfluidic separating system.

In one example, the final fluid sample comprises 3 percent or less of white blood cells that were contained in the fluid sample prior to the initial separation operation.

In one example, the final fluid sample comprises a Newtonian fluid. More specifically, the initial fluid sample is generally a viscoelastic fluid. However, because of reflowing sperm fluid volume with a dilution fluid and repeating the separation processes, the fluid flowing through the spiral microchannel structure becomes more and more Newtonian during each subsequent reflow. Thus, the final fluid volume comprises a Newtonian fluid.

In one example, the method further comprises transitioning the fluid sample from a viscoelastic fluid to a Newtonian fluid because of repeating the flowing operation and subsequent separation operation, such as noted and discussed above.

In one example, the first sperm fluid volume has a viscosity greater than a viscosity of the second sperm fluid volume. This is because the reflowing operations in which the fluid sample is diluted during each reflowing operation.

In one example, the microfluidic separating system comprises a spiral microchannel structure, and wherein the reflowing operation and subsequent separation operation occurs via the spiral microchannel structure. For instance, see the spiral microchannel 210 of FIGS. 2-4 and 6 that is used for reflowing and separating operations discussed herein. The spiral microchannel structure can simply be composed of a single spiral where the sample is serially reflowed through it.

In one non-limiting example, the microchannels are fabricated using photolithography to generate molds and soft lithography to generate devices. The channel geometry can be designed using CAD software and patterned onto a 5-inch chromium/glass mask. A SU-8 based mold was fabricated via UV light exposure and development. The photoresist thickness was set to match the designed channel height. The polydimethylsiloxane (PDMS) devices were made by pouring uncured PDMS solution (mixed with curing agent at a ratio of 10:1) on the SU-8 mold and later baked in an oven at 80° C. for 4 hours. Then the PDMS layer was peeled off from the mold and bonded with glass after the oxygen plasma treatment.

Flow rates can be controlled by pumps such as syringe pumps. To preserve sperm cell viability, the system can be temperature controlled. For example, the system can be operated inside an incubator.

In one example a breadboard and alpha prototype of the device is provided. Most of the experiments can be performed on a breadboard system which can include four computer-controlled syringe pumps operated inside of an incubator. This breadbox system can contain all necessary pumps, valves, and heating elements inside of a transportable, automated system that can be operated with a touch-screen interface. This system is more user friendly than prior systems.

A tangential filter often fails due to clogging and cells are irretrievably stuck to the filter. The tangential filter is a commonly used for pre-processing of the seminal plasma. The spiral channel also resolves these issues because it can be used for washing to remove seminal plasma. With the spiral channel providing the washing step, the only need for filtration would be to reduce the sample volume. Sample volume reduction can still be achieved according to the amount of fluid shunted to the unselected portion. Therefore, combining the operation modes of dilution and reduction in a spiral channel connected in series can achieve some or all the goals of semen preparation.

As discussed above, the reflowing operation through the spiral microchannel can take place multiple times. Initially, the sperm fluid volume 200 that is flowed through spiral microchannel 210 is a viscoelastic or a non-Newtonian fluid. As the sperm fluid volume is repeatedly reflowed through the microfluidic separating system with dilution fluid 202, the sperm fluid volume transitions from a viscoelastic fluid to a Newtonian fluid. In one example, the final fluid sample comprises at least 80% of the sperm cells that were contained in the fluid sample prior to the initial separation operation. As a general guideline, fluid samples can have an initial sperm concentration of 1-100 M/ml and a final concentration of 10-1000 M/ml, although concentrations outside these limits can be achieved.

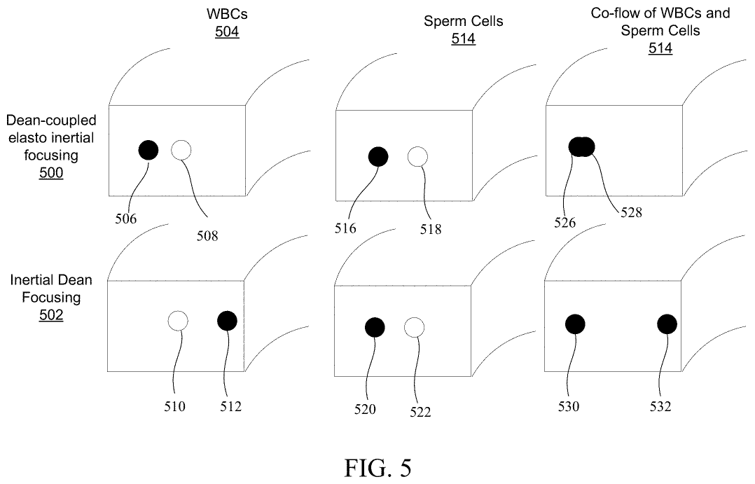

The transition of the fluid sample to a Newtonian fluid is achieved within 5 percent of linear dependency of viscosity as a function of shear rate. The transition from a viscoelastic fluid to a Newtonian fluid is an important part of separation. One observed phenomenon is that when there is a high concentration of seminal plasma, separation between the WBC's and the sperm cells is very low. This happens because, semen is viscoelastic, and exhibits a different viscosity depending on the shear rate that is applied. The Dean flow-based separation mechanism is insufficient for separating sperm from WBCs when they are suspended together in seminal plasma. Particles suspended in viscoelastic fluid are driven towards the center of the channel. The spiral microchannel uses both Dean-coupled elasto-inertial focusing and inertial Dean focusing forces for particle selection and separation. Essentially, the sperm and the WBC's in a high concentration of seminal plasma are focused together to the outer outlet, which inhibits separation. FIG. 5 schematically illustrates Dean-coupled elasto-inertial focusing in the channel. These forces can cause the particles to be focused on the outer wall of the channel. This happens because the viscoelasticity of the carrier fluid drives particles to the center of the channel where the direction of the Dean flow is towards the outer wall. The Dean-coupled elasto-inertial forces are effective for particle alignment. Thus, in a high concentration of seminal plasma, the sperm cells are driven to the center and the subsequent Dean forces act on the sperm cells to push it towards the outer wall. This has been widely explored in both theory and application.

Sperm cells predominantly occupy the outer half of the channel while WBCs predominantly occupy the inner part of the channel. This likely happens due to morphological differences between sperm cells and WBCs. Scenario 500 illustrates that Dean-coupled elasto-inertial focusing for WBCs 504 is towards the outer wall 506 but would be more towards the middle of the channel 508 if the channel were straight. In contrast, inertial dean focusing 502 shows that the WBCs 504 are focused on the inside of the channel 512. Scenario 502 at 510 shows that the WBCs would normally be in the middle of the channel if the channel were straight. Sperm cells 514 show focusing on the outside of the channel for Dean-coupled elasto-inertial focusing 500 while 518 indicates focus towards the middle if the channel were straight. For inertial Dean focusing 502, 520 and 522 indicates that the sperm's focus does not change significantly from 500. Scenario 514 illustrates the co-flow of WBCs and sperm cells. For the Dean-coupled elasto-inertial focusing 500, one can see that the sperm 526 and WBCs 528 fail to separate. For inertial Dean focusing 502 the sperm 530 and WBCs 532 effectively separate. Dean focusing for Newtonian fluids relies on shear lift force, wall lift forces, and Dean drag. The addition of dilution fluids with the sperm fluid volume aids in reducing the high concentration of seminal plasma such that the sperm and WBCs effectively separate. As discussed above, this happens because the dilution fluid makes the sperm fluid volume less viscoelastic and more Newtonian. With each subsequent re-run with dilution fluid the sperm fluid becomes even more Newtonian. Thus, the Dean-coupled elasto-inertial forces can be used to align the sperm cells to a certain position in the spiral channel while the addition of dilution fluid media makes use of the inertial Dean focusing to separate the sperm from the WBCs. This largely occurs because of the round/sphere morphology of WBCs and the asymmetric morphology of sperm cells.

The following equations address the theoretical considerations for designing the devices and spiral microchannel channel dimensions. Inertial focusing is based on the observed phenomenon of particles focusing to specific positions of channel cross-section in confined flows (Carlo et al. 2007). The inertial focusing phenomenon is observed when a particle has commensurate dimension with the channel dimension. Inertial focusing is represented by:

$${L}_{f} = \frac{π μ}{ρ {U}_{m} {β}^{2} {f}_{L}}$$

Where L_{f} is the inertial focusing channel length, f_{L} is the shear lift force coefficient, Uₘ the maximum flow velocity, μ is the fluid viscosity, β the channel block ratio, and p the fluid density. The channel block ration β, the ratio of particle diameter a to channel height h, can generally be above 0.07 for particle focusing in microchannel. The channel block ratio can be represented as:

β=a/h.

Due to the parabolic velocity profile in microchannels, the shear gradient lift force (F_{L}) leads to particle lateral movement towards the wall, which is counterbalanced by the repulsive wall effect. The shear gradient lift force (F_{L}) is represented as:

F_{L}=f_{L}ρUₘ²α²β²

Where f_{L} is the shear lift force coefficient, Uₘ the maximum flow velocity, p the fluid density, a is the particle diameter and 62 is the channel block ratio. As a result, particles get focused to equilibrium positions. In rectangular shaped microchannel cross-sections, particles have two equilibrium positions near the center of the top and bottom wall. In spiral channels, the particle focusing effect is changed due to the existence of secondary flow across the channel cross-section and perpendicular to the primary flow. These secondary vortices are caused by differential path lengths in the channel and inertial drift of flows towards the outside of a small radius spiral channel. For a spiral channel radius, the Dean number can be calculated by using:

De=Re(Dₕ/2R)^{0.5}

Where Dₑ is the Dean number, Dₕ the hydraulic diameter, Rₑ the Reynolds number, and where R is the radius of the spiral channel. Non-spherical particles have an infinite number of periodic rotations known as Jeffery orbits. While particle movement is dominated by shear flow, flow perturbation affects particle rotational status. The Reynolds number influences the tumbling rotation and tumbling frequency of high aspect ratio particles. The Particle Reynolds number is represented by:

$${Re}_{p} = Re {β}^{2} = \frac{p U {D}_{h} {a}^{2}}{μ {h}^{2}}$$

Where Reₚ is the Particle Reynolds number, p is fluid density and μ is fluid viscosity. While the channel aspect ratio is represented by:

AR=h/w

Where AR is the aspect ratio, h is the height and w is the width. The alignment of high aspect ratio particles in inertial flow leads to the change of particle focusing positions. The Dean vortices generated in the channel cross-section do not contribute to the inertial focusing process, but they deliver the focused particle streams towards new focusing positions. Dean flow accelerates particle inertial focusing and contributes to the separation of particles with different sizes. The Dean Flow drag force is:

F_{D}=5.4×10⁻⁴πμDe^{1.63}a

And the hydraulic diameter is represented by:

$${D}_{h} = \frac{2 h w}{h + w}$$

where h is the channel height and w is the channel width. These Dean flow equations provide the theoretical backdrop for designing a spiral microchannel that can effectively separate sperm from WBCs.

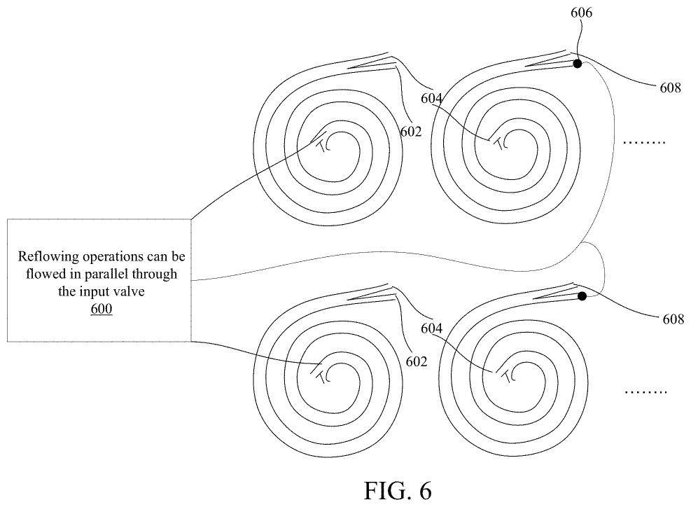

FIG. 6 schematically illustrates the microfluidic separating system used in parallel with another spiral microchannel structure. The reflowing operations and subsequent separations occur through both microchannel structures set up in parallel and can also be connected with other spiral microchannel structures in series. As indicated in 600, this parallel set-up helps to further cut down process time by half (i.e. compared to a single device of the same size) by running portions of the fluid sample in parallel. The debris volume 602 or 606 that comes out from the unselected portion can also be reflowed in parallel to recover any lost sperm for further sperm enrichment. This method allows for a small recovery of sperm that would typically be stuck with the WBCs. Sperm outputs 604 and 608 from the outlet are considered sperm rich. This operation method of running the fluid volumes in parallel can be done multiple times for enhanced enrichment and separation. Thus, a parallel setup not only makes the enrichment and separation process quicker, it also can be used to yield a greater amount of sperm separation.

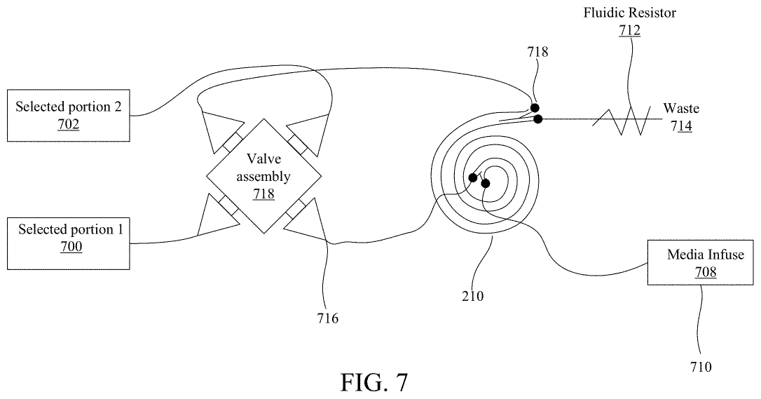

FIG. 7 schematically illustrates one example hardware setup for automated sperm preparation. The microfluidic separating system comprises of a controller 718, pumps 716, and a spiral microchannel structure 210. The controller can be configured to control the pumps for flowing the fluid sample through the spiral microchannel structure and automatically repeating the reflowing operation and the subsequent separation operations. The controller 718 can be controlled using a Matlab program that controls the pumps and valves (see 718 and 716), although other software control programs can be used based on these principles. This system essentially moves a selected portion back and forth between two syringes, i.e. 700 and 702, labeled as Selected portion 1 and selected portion 2. The waste portion 714 can be run throw fluidic resistor 712 to be removed and media 708 is infused from a third syringe pump 710. This process can be controlled by a single valve which allows either syringe pump to direct flow to the inlet of the spiral channel. Signals from controller 718 open and close the valves to allow for the selected portion of the fluid volume to flow through spiral microchannel 210. The enriched portion 718 can be sent back to 702, selected portion 2 and can be subsequently run through spiral microchannel separator 210 again. The flowing, reflowing, and separation mediated by the controller allows for this process to be automated. The instrumentation described herein takes the sample all the way from the collection cup to an IUI syringe to pursue a hands-free protocol. Controller 718 can also be configured to control an incubator which heats portions of the sperm fluid volume. As mentioned above in the separation method. Heating is typically desired when there are gaps in the time of the enrichment and separation process taking place. Syringes, media, and plastics that contact the sperm cells can also be heated.

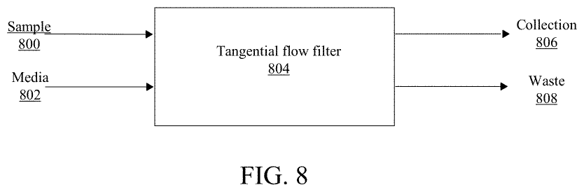

FIG. 8 schematically illustrates a tangential flow filter for further washing cells from seminal plasma to reduce the total volume. The use of the tangential flow filter can be used in tandem with the methods described above. The tangential flow filter could help in the separation of the seminal plasma from the sperm and subsequently have the enriched sperm fluids flowed through the spiral microchannel. As indicated in 700, the sample is flowed through the tangential flow filter 704 along with media 702 and the output 706 is collected to be further enriched and separated while 708 is debris waste that is not collected.

### EXAMPLE 1

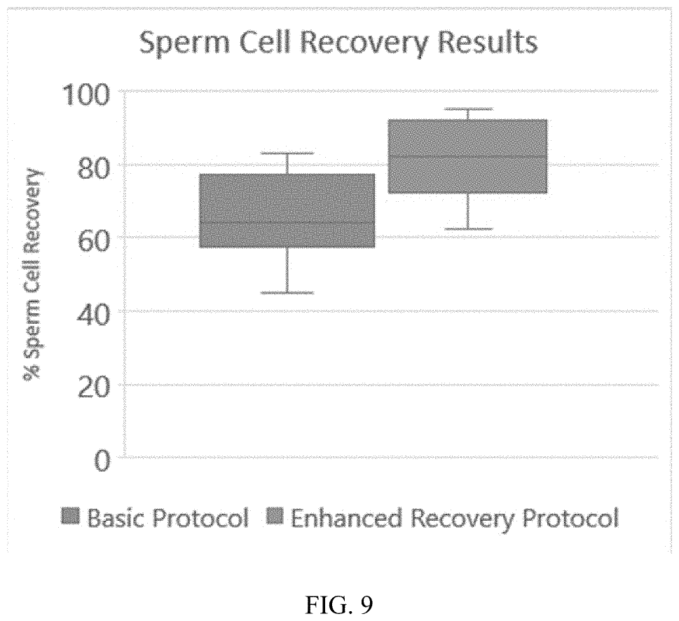

FIG. 9 illustrates a final fluid sample having about 70-90% sperm cell recovery using the enhanced recovery protocol exemplified further below. In one example FIG. 9 graphically shows data on the difference between the basic protocol and enhanced recovery protocol. In the basic protocol, fractions of the sample are permanently assigned to the unselected portion as described above while in the enhanced recovery protocol, sample that is assigned to the unselected portion is re-run through the spiral channel again to recover an additional fraction of high quality sperm that would otherwise be discarded.

Using the basic protocol the device and methods described herein can recover an average of 65% of all sperm in the final selected portion, while removing 87% of the WBCs in a protocol which requires less than 15 minutes to run (e.g., FIG. 9). This can outperform a DGC and can achieve performance metrics that are commercially viable. The present technology can further be used to enhance the probability of pregnancy for samples with extremely low sperm counts (10-20M total motile sperm), and therefore the present disclosure provides the enhanced recovery protocol which is able to recover >80% of sperm cells from a sample (e.g., FIG. 9). Since this protocol may be more involved (although still fully automatable), this may be employed with samples in which sperm count is a specific concern.

The present disclosure further provides an “Enhanced WBC Removal Protocol” which could be used with samples of extremely high WBC concentration and can remove >97% of WBCs from a sample, with a modest sacrifice of time (˜20 minutes) and sperm cell recovery. An enhanced recovery protocol can include more dilution cycles through the loop and can include rerunning the unselected or debris components through the microfluidic device.

### EXAMPLE 2

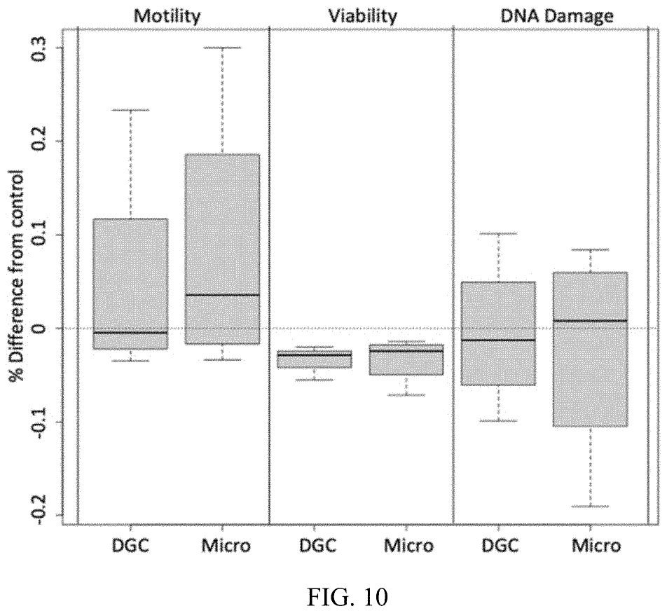

The method of reflowing and separating through a spiral microfluidic channel is also shown to not impose any damage on the sperm cells like a centrifugal method would. The data from FIG. 10 was gathered via a paired blinded analysis of samples where samples were split equally between DGC, microfluidic processing, and control portions. FIG. 10 shows factors such as progressive motility, the percentage of living vs. dead cells, and the level of DNA damage in the sperm populations are looked at. There was found to be no statistical significance in any of these assessments. Thus, the spiral microchannel using dilution fluid for its separation operation is shown to retain the same sperm viability, motility, and DNA integrity as DGC.

### EXAMPLE 3

FIG. 11 shows that when the concentration of seminal plasma is high, the same separation was not observed between WBCs and sperm cells as when the concentration of seminal plasma is low. FIG. 11 graphically depicts the effect of seminal plasma concentration on the focusing of WBC's to the unselected portion. The bottom graph highlights the sub-region of this figure from 00-10% seminal plasma vt % in plasma-SWM dilution. One can see that with low amounts of seminal plasma vt % that a higher percentage of WBCs are directed to the unselected portion. As discussed above, an explanation for this behavior can be discerned from a fundamental physics perspective: like many biological fluids, semen is viscoelastic, exhibiting a different viscosity depending on the shear rate that is applied. It has been shown that particles suspended in a viscoelastic fluid will be driven towards the center of a channel, even when that channel is straight and regardless of particle size. In semen, even when diluted with small amounts of sperm media, this effect can be dominant over the separation than expected to be observed in the spiral channel, and that the sperm and WBCs were focused together to the outer outlet, inhibiting the ability to create a separation. As shown in FIG. 11, one effective way to solve this problem can be to dilute the semen and show that when the semen is diluted in sperm washing media at around 1.5 vt % a separation between sperm and WBCs can be achieved.

### EXAMPLE 4

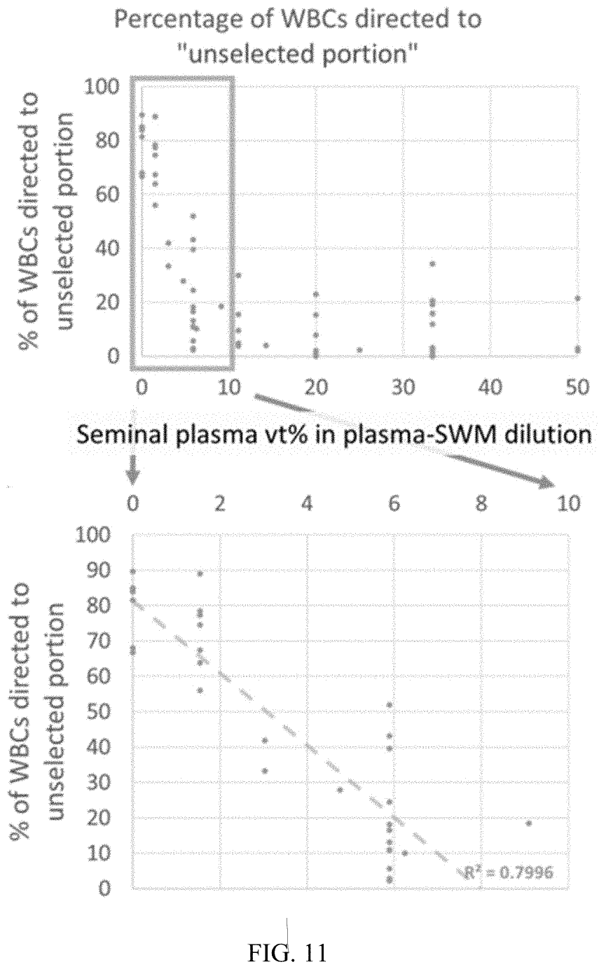

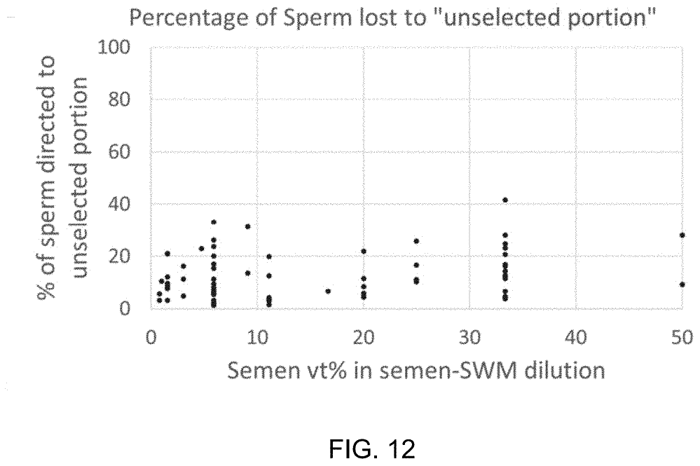

FIG. 12 shows the effect of seminal plasma concentration on the loss of sperm to the unselected portion. One can see that the high seminal plasma vt % does not seem to significantly affect how much sperm is directed towards the unselected portion. Unlike WBCs, sperm are unaffected by the dilution and are unlikely to be directed to the unselected portion regardless of dilution (e.g., FIG. 12).

### EXAMPLE 5

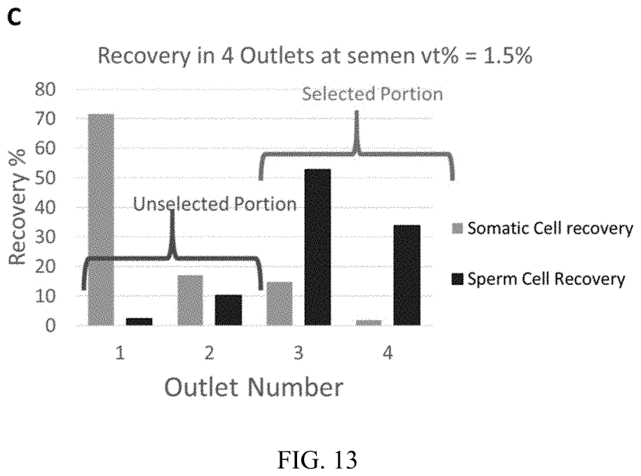

As shown in FIG. 13, the WBCs can be very easily separated from the sperm cells at a dilution of 1.5 vt %. Typically, this type of data has always been presented using samples that had either been washed from seminal plasma using a centrifuge, or from sperm which were obtained from testicular biopsy samples. But the data shown in FIG. 13 is obtained from dilution in a spiral microchannel. FIG. 13 shows that the selected portion has a much higher recovery rate of sperm and a low somatic cell recovery while the unselected portion has low sperm recovery and high somatic cell recovery.

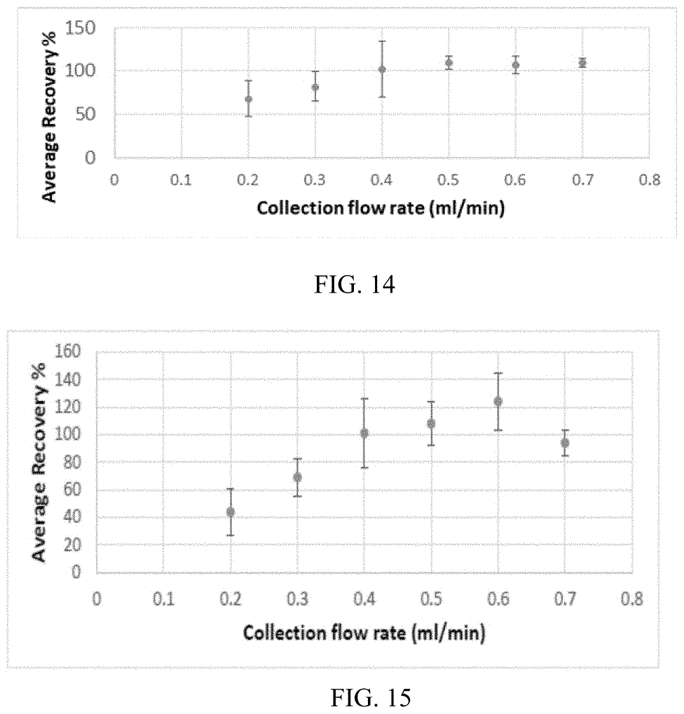

A polycarbonate device with a filter membrane using the principles of tangential flow filtration was used to test the average recovery rate of microbeads. The polycarbonate device was run at different collection flow rates and is connected to syringe pumps. Injection flow rate was kept constant at 0.4 ml/min to push in the fluid and collection flow rate was varied from 0.7-0.2 ml/min in each run. Recovery of microbeads was recorded for each run and after each run the device was washed with media. As indicated in FIG. 14, for the collection flow rates of 0.7-0.4 ml/min the recovery of sperm was at least 90%. At 0.2 ml/min the recovery percentage dropped dramatically which can likely be explained by the slower movement of the beads which leads to adhesion with the filter.

A second filter (filter-2) was used that was designed to stop the adhesion of mammalian cells on the filter surface. Filter-2 had larger pore sizes of 1 micrometer. Tests were performed on this filter-2 by using washed sperm in media. The test protocols were the same as the example above for the polycarbonate device. As indicated in FIG. 15, more than 90% of sperm recovery was observed in the range of flow rates of 0.7-0.4 ml/min for washed sperm in media.

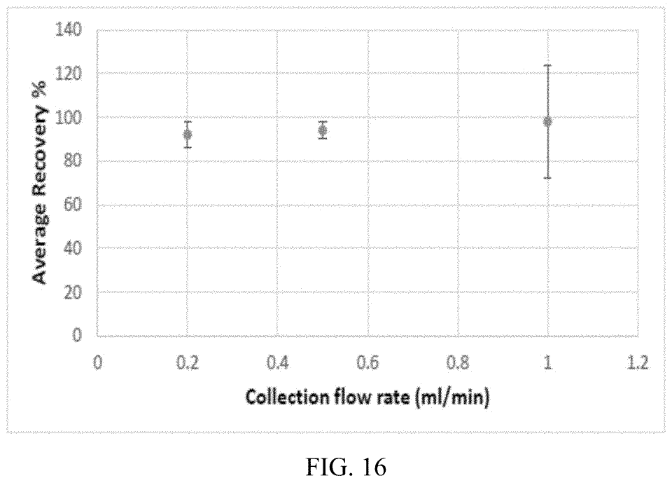

In one example, an attempt to process raw semen with filter-2 was made, but the recovery percentage was below 90%. This was likely due to clogging of the filter's pores with seminal plasma and other cell debris present in the raw semen. To counter this problem, an attempt to pre-dilute the raw semen sample with media at different dilution ratios was made. As indicated in FIG. 16, recovery rate was more than 90% for sperm, but the pre-diluted sample was only 0.5 mL. At 1 mL of pre-diluted volume the recovery rate was much lower (68%).

### EXAMPLE 6

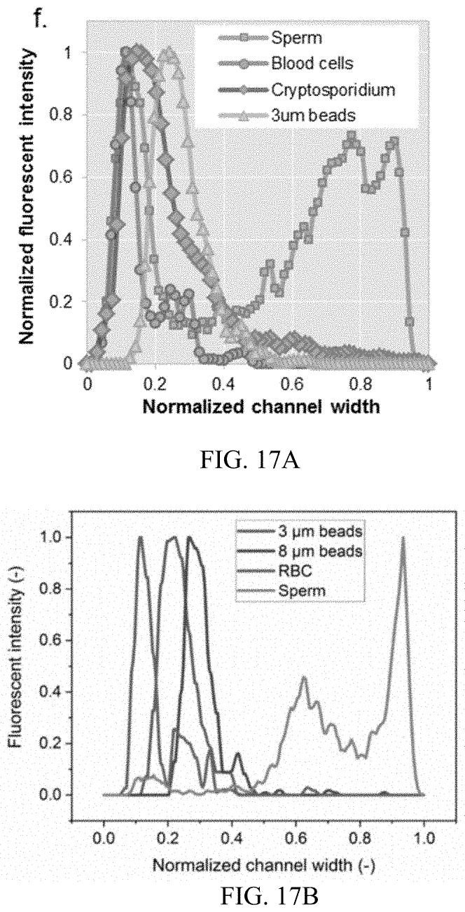

Separation of sperm is shown to exhibit a bimodal distribution, as graphically illustrated in FIG. 17A and 17B. The method of reflowing consecutive sperm fluid volumes from repeating the reflowing operations appears to contribute to the bimodal distribution that is shown. This bimodal distribution appears to be due to morphological differences between sperm and other cells in the microfluidic separating system. Typically, it is expected that particles of a given size will focus into a single stream. However, FIG. 17A and 17B indicates that this is not the case for sperm. As observed with other micro particles of similar size, the 1.3μm size of sperm would conventionally lead one to think that it would focus on the inside of the channels. But instead, sperm focuses on the outside of the channel. Each batch of sperm fluid volume that is reflowed through the microfluidic separating system is accompanied by a new volume of dilution fluid. As discussed above, from repeating the reflowing operation, a bimodal distribution can be developed and exhibited due to morphological differences between sperm and other cells that are accentuated due to the Dean forces in the microfluidic separating system. Discussed in more detail below with respect to FIG. 17A and 17B, the bimodal distribution appears to be a somewhat unusual and unexpected result of this separation process as applied to sperm.

At least one of the consecutive sperm fluid volumes will include sperm distinctly separated not simply from the fluid volumes, but also from other non-sperm particles of similar size in the corresponding debris fluid volume. As discussed above, separation of similarly sized particles seems to be at least partially driven by shape differences. The unique focusing position of sperm in a spiral channel device comes from the co-effect shear lift forces, wall repulsive forces, and Dean Flow. These forces make separation of sperm from more spherical non-sperm cells possible. Sperm have focusing streams near channel outer sidewall, while non-sperm cells have focusing streams near the channel inner sidewall. Shape based separation is achieved by controlling particle movement in inertial flow.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A method of isolating sperm of a fluid sample, comprising:
separating, in an initial separation operation, the fluid sample via a microfluidic separating system into a first debris fluid volume and a first sperm fluid volume;
reflowing the first sperm fluid volume and a dilution fluid through the microfluidic separating system to reprocess the first sperm fluid volume; and
separating, in a subsequent separation operation, the first sperm fluid volume into a second debris fluid volume and a second sperm fluid volume via the microfluidic separating system.

2. The method of claim 1, further comprising repeating the reflowing operation and the subsequent separation operation to produce consecutive sperm fluid volumes and corresponding debris fluid volumes separated by the microfluidic separating system, such that a dilution fluid is combined with each consecutive sperm fluid volume flowed through the microfluidic separating system.

3. The method of claim 2, wherein repeating the reflowing operation and subsequent separation operation produces a final fluid sample, the final fluid sample comprising at least 65 percent of the sperm cells that were contained in the fluid sample prior to the initial separation operation.

4. The method of claim 3, wherein the final fluid sample comprises at least 80 percent of the sperm cells that were contained in the fluid sample prior to the initial separation operation.

5. The method of claim 3, wherein the final fluid sample is produced in less than 20 minutes from the initial separation operation.

6. The method of claim 3, wherein the final fluid sample is 2.5 mL or less.

7. The method of claim 3, wherein the final fluid sample comprises 3 percent or less of white blood cells that were contained in the fluid sample prior to the initial separation operation.

8. The method of claim 2, wherein the final fluid sample comprises a Newtonian fluid.

9. The method of claim 2, wherein repeating the reflowing operation and the subsequent separation operation is performed at least four times.

10. The method of claim 2, further comprising transitioning the fluid sample from a viscoelastic or non-Newtonian fluid to a Newtonian fluid as a result of repeating the flowing operation and subsequent separation operation.

11. The method of claim 10, wherein transitioning the fluid sample to a Newtonian fluid is achieved within 5 percent of linear dependency of viscosity as a function of shear rate.

12. The method of claim 2, wherein at least one of the consecutive sperm fluid volumes from repeating the reflowing operations exhibits a bimodal distribution due to morphological differences between sperm and other cells in the microfluidic separating system.

13. The method of claim 2, wherein at least one of the consecutive sperm fluid volumes includes sperm distinctly separated from other non-sperm particles of similar size in the corresponding debris fluid volume, at least partially due to shape differences driving separation of similarly sized particles.

14. The method of claim 1, wherein the first sperm fluid volume has a viscosity greater than a viscosity of the second sperm fluid volume.

15. The method of claim 1, wherein the microfluidic separating system comprises a spiral microchannel structure, and wherein the reflowing operation and subsequent separation operation occurs via the spiral microchannel structure.

16. The method of claim 15, wherein the microfluidic separating system comprises a complementary spiral microchannel structure, and wherein the reflowing operation and subsequent separation operation occurs via the spiral microchannel structure and the complementary spiral microchannel structure.

17. The method of claim 15, wherein the spiral microchannel structure includes an inlet and an outlet, wherein the outlet includes a branched flow splitter having a sperm fluid outlet oriented to receive the first sperm fluid volume and a debris outlet oriented to receive the first debris fluid volume, and wherein the inlet includes a sperm fluid inlet to receive the first sperm fluid volume and a dilution fluid inlet to receive the dilution fluid.

18. The method of claim 1, wherein the microfluidic separating system comprises a separation instrument comprising a controller, pumps, and a spiral microchannel structure, the controller configured to control the pumps for flowing the fluid sample through the spiral microchannel structure.

19. The method of claim 18, further comprising automatically repeating the reflowing operation and the subsequent separation operation, via the controller, to produce consecutive sperm fluid volumes separated by the spiral microchannel structure.

20. The method of claim 18, wherein the controller is configured to control valves and further comprising an incubator which heats at least portions of the sperm fluid volume.

21. The method of claim 1, further washing cells from seminal plasma using a tangential filtration unit so as to reduce a total volume.
